(19) United States
(12) Patent Application Publication
(10) Pub. No.: US 2012/0163475 A1
(43) Pub. Date: Jun. 28, 2012

(54) FAST MATCHING SYSTEM FOR DIGITAL VIDEO

(75) Inventors: Sang Il NA, Seoul (KR); Weon Geun OH, Daejeon (KR); Hyuk JEONG, Daejeon (KR); Sung Kwan JE, Daejeon (KR); Keun Dong LEE, Daejeon (KR); Dong Seok JEONG, Seoul (KR); Ju Kyong JIN, Incheon (KR)

(73) Assignee: Electronics and Telecommunications Research Institute, Daejeon (KR)

(21) Appl. No.: 13/333,120

(22) Filed: Dec. 21, 2011

(30) Foreign Application Priority Data
Dec. 23, 2010 (KR) 10-2010-0133079

(51) Int. Cl. G06K 9/46; H04N 7/26

(52) U.S. Cl. 375/240.25; 382/201; 375/E07.027

(57) ABSTRACT

A fast matching system for a digital video is provided. The fast matching system includes a video feature point extractor for extracting feature points of video frames of a digital video when the digital video is input, a feature point index mapper for receiving the video feature points from the video feature point extractor and configuring an index table by mapping the video feature points to a plurality of indices, a video feature point database (DB) for storing the index table, and a video feature point comparator for outputting video information corresponding to matched indices by comparing the video feature points extracted by the video feature point extractor with the indices of the index table stored in the video feature point DB.

### CLAIM FOR PRIORITY

This application claims priority to Korean Patent Application No. 10-2010-0133079 filed on Dec. 23, 2010 in the Korean Intellectual Property Office (KIPO), the entire contents of which are hereby incorporated by reference.

### BACKGROUND

1. Technical Field

Example embodiments of the present invention relate to a fast matching system for a digital video.

2. Related Art

Recently, the rapid development of a network has enabled composition, creation, processing, and distribution of various multimedia content based on the Internet or the like.

Accordingly, there is a need for a digital video management system capable of efficiently managing digital videos for various multimedia services based on recognition technology for finding information regarding encoded digital media of which sources and information are incapable of being recognized by previous technology, search technology for searching for videos in which the same content is partially redundant, and technology for managing and searching for videos broadcast through various media or videos spread on a large network such as the Internet. Unlike existing methods, a method of comparing two input moving images at a high speed is provided according to the present proposal.

It is difficult for large-capacity digital video management and search systems of the related art to perform a fast matching operation between two digital videos.

### SUMMARY

Accordingly, example embodiments of the present invention are provided to substantially obviate one or more problems due to limitations and disadvantages of the related art.

Example embodiments of the present invention provide a fast matching system for a digital video that can perform a fast matching operation on a digital fingerprint.

In some example embodiments, a fast matching system for a digital video includes: a video feature point extractor configured to extract feature points of video frames of a digital video when the digital video is input; a feature point index mapper configured to receive the video feature points from the video feature point extractor and configure an index table by mapping the video feature points to a plurality of indices; a video feature point database (DB) configured to store the index table; and a video feature point comparator configured to output video information corresponding to matched indices by comparing the video feature points extracted by the video feature point extractor with the indices of the index table stored in the video feature point DB.

The feature point index mapper may configure a total frame index table by mapping frame position information to indices assigned to feature points of all video frames constituting related moving images, and configure a key-frame index table by mapping frame position information to indices assigned to feature points of key frames among all the video frames constituting the related moving images.

The video feature point extractor may include: a video decoding unit configured to recover video frames by decoding a compressed digital video; a video feature extraction unit configured to extract feature points and video frame information from all the recovered video frames; and a video feature arrangement unit configured to arrange the video frame information in correspondence with the video feature points.

The feature point index mapper may include: an index extraction unit configured to receive the video feature points and video frame information corresponding to the video feature points and extract indices corresponding to the feature points from the video frame information; a total index arrangement unit configured to configure a total frame index table by mapping video frame information to indices assigned to feature points of all video frames constituting related moving images; and a key-frame index arrangement unit configured to configure a key-frame index table by mapping video frame information to indices assigned to feature points of key frames among all the video frames constituting the related moving images.

The video frame information may include information regarding positions of the video frames.

The video feature point comparator may receive the video feature points from the video feature point extractor, and compare indices corresponding to feature points of all received frames with indices of a total frame index table stored in the video feature point DB.

The video feature point comparator may receive the video feature points from the video feature point extractor, and compare indices corresponding to feature points of a key frame among all received frames with indices of a key-frame index table stored in the video feature point DB.

The video feature point comparator may receive the video feature points from the video feature point extractor, and compare indices corresponding to feature points of a key frame among all received frames with indices of a total frame index table stored in the video feature point DB.

### BRIEF DESCRIPTION OF DRAWINGS

Example embodiments of the present invention will become more apparent by describing in detail example embodiments of the present invention with reference to the accompanying drawings, in which:

FIG. 1 is a schematic block diagram showing a fast matching system for a digital video as a digital video management and search system according to an example embodiment of the present invention;

FIG. 2 is a block diagram of a video feature point extractor for receiving a digital video and extracting video feature points;

FIG. 3 is a block diagram of a feature point index mapper according to an example embodiment of the present invention;

FIG. 4 shows an example of an index table configuration according to an example embodiment of the present invention; and

FIG. 5 shows an example of index matching according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments of the present invention will be described in detail with reference to the accompanying drawings.

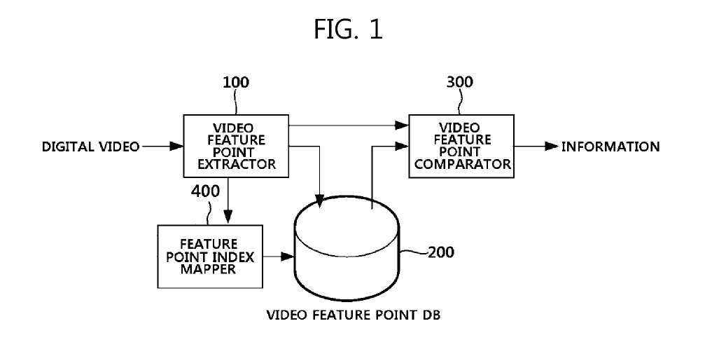

FIG. 1 is a schematic block diagram of a fast matching system for a digital video according to an example embodiment of the present invention. Operation of the fast matching system for the digital video will be described below with reference to FIG. 1.

The fast matching system for the digital video includes a video feature point extractor 100, a video feature point database (DB) 200, a video feature point comparator 300, and a feature point index mapper 400.

The video feature point extractor 100 receives a digital video signal. Here, the input digital video may have various types and sizes. Various types include video files encoded by various compression techniques, and various sizes include a frame rate and a bit rate as well as horizontal and vertical sizes of a video. Videos to which various types of intended/unintended modifications are applied may also be included. Representative modification examples include a caption, a logo insertion, a video contrast variation, a capture, and the like.

The video feature point extractor 100 extracts feature points from the input digital video. The feature points extracted by the video feature point extractor 100 may be input to the video feature point DB 200 and the feature point index mapper 400.

The feature point index mapper 400 may receive the video feature points from the video feature point extractor 100 and map the video feature points to a plurality of indices.

The video feature point DB 200 may store information regarding the feature points extracted by the video feature point extractor 100, and also receive and store a feature point index table provided from the feature point index mapper 400.

The video feature point comparator 300 outputs stored video information by comparing information extracted by the video feature point extractor 100 with information searched for by the video feature point DB 200 using the extracted information.

As described above, the video feature point extractor 100 may extract the video feature points and the video feature point comparator 300 may perform a fast matching operation on the extracted video feature points.

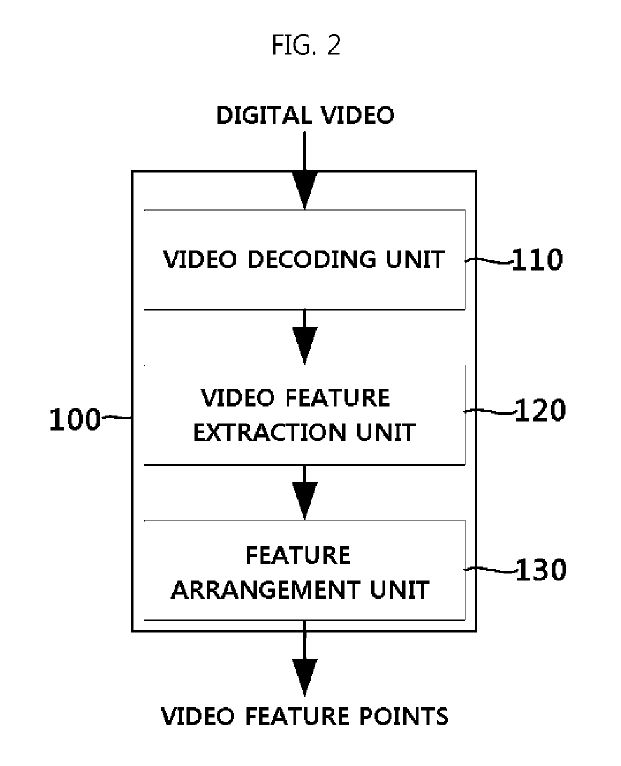

FIG. 2 is a block diagram of the video feature point extractor for receiving a digital video and extracting video feature points.

The video feature point extractor 100 includes a video decoding unit 110, a video feature extraction unit 120, and a feature arrangement unit 130.

A digital video to be input to the video feature point extractor 100 may be compressed by various encoders. The video decoding unit 110 recovers video frames before compression by decoding all types of compressed digital videos.

The video feature extraction unit 120 extracts features of the recovered video frames. Also, the video feature extraction unit 120 extracts video feature points and information of a key frame to be used by the feature arrangement unit 130. Specifically, the video feature extraction unit 120 extracts feature points of all frames and a position of the key frame.

The feature arrangement unit 130 arranges extracted video feature points for the corresponding video frame. That is, the feature arrangement unit 130 arranges video frame position information in correspondence with the video feature points. Also, the feature arrangement unit 130 outputs the video feature points and information regarding the video frame corresponding to the video feature points to the feature point index mapper 400.

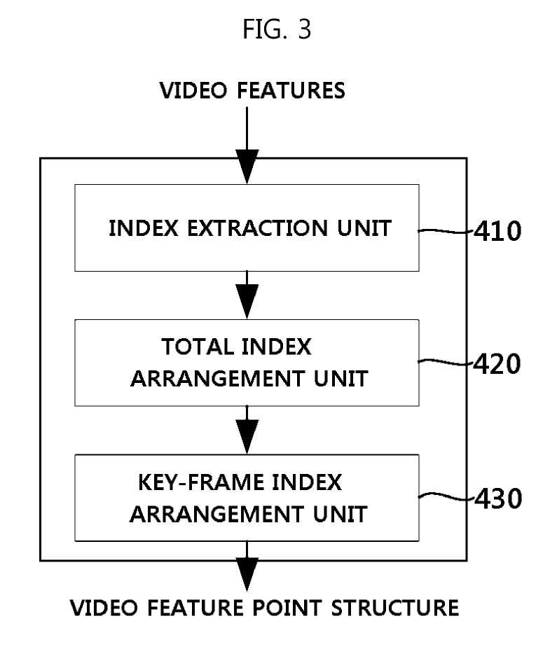

FIG. 3 is a block diagram of the feature point index mapper according to an example embodiment of the present invention. The feature point index mapper 400 receives information from the video feature point extractor 100, and makes an arrangement in the form in which the information may be searched at a high speed by extracting index information.

For this, the feature point index mapper 400 includes an index extraction unit 410, a total index arrangement unit 420, and a key-frame index arrangement unit 430.

The index extraction unit 410 receives video feature points and information regarding a video frame corresponding to the video feature points, and extracts indices corresponding to the feature points from the video frame information. The extracted indices are provided to the total index arrangement unit 420. The total index arrangement unit 420 configures an index table storing the extracted indices and frame position information corresponding to the extracted indices.

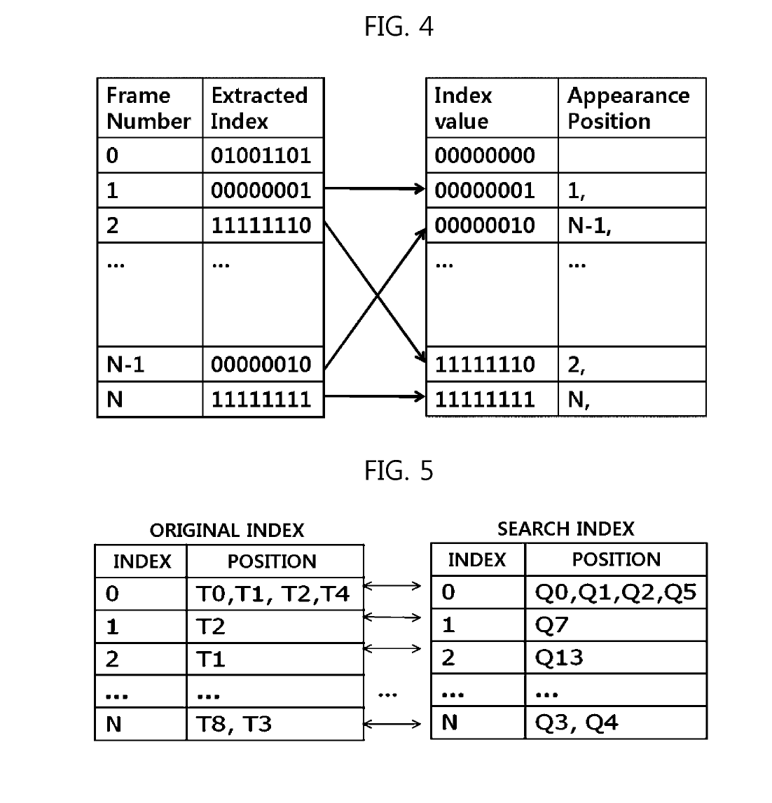

FIG. 4 shows an example of an index table configuration according to an example embodiment of the present invention. An index table shown on the left of FIG. 4 stores indices corresponding to feature points extracted in correspondence with positions of a plurality of video frames constituting moving images. That is, the plurality of video frames respectively have video feature points, and the indices are assigned to the feature points of the plurality of video frames.

According to an example embodiment of the present invention, the total index arrangement unit 420 configures a total frame index table such as an index table shown on the right of FIG. 4 by mapping frame position information to indices assigned to feature points of all video frames constituting related moving images.

The key-frame index arrangement unit 430 configures a key-frame index table by mapping frame position information to indices assigned to feature points of key frames among all the video frames constituting the related moving images.

According to an example embodiment of the present invention as described above, the total frame index table in which the frame position information is mapped to the indices assigned to the feature points of all the video frames constituting the related moving images and the key-frame index table in which the frame position information is mapped to the indices assigned to the feature points of the key frames among all the video frames constituting the related moving images are stored in the video feature point DB 200, and are later used for a video search.

If information extracted from an input digital video is input, the video feature point comparator 300 first performs an index matching operation. Specifically, if the digital video is input to the fast matching system for the digital video as a digital video management and search system, the video feature point extractor 100 extracts video feature points and provides the extracted video feature points to the video feature point comparator 300.

If the video feature points are received from the video feature point extractor 100, the video feature point comparator 300 compares or matches indices corresponding to feature points of all received frames with indices of the total frame index table stored in the video feature point DB 200. As described above, in the total frame index table, the frame position information is mapped to the indices assigned to the feature points of all the video frames constituting the related moving images.

According to another example embodiment, if the video feature points are received from the video feature point extractor 100, the video feature point comparator 300 compares or matches indices corresponding to feature points of a key frame among all the received frames with indices of the key-frame index table stored in the video feature point DB 200. As described above, in the key-frame index table, the frame position information is mapped to the indices assigned to the feature points of the key frames among all the video frames constituting the related moving images.

According to another example embodiment, the feature point comparator 300 compares or matches the indices corresponding to the feature points of the key frame among all the received frames with the indices of the total frame index table stored in the video feature point DB 200.

FIG. 5 shows an example of index matching according to an example embodiment of the present invention.

Index matching is performed by comparing feature points between positions having the same index. Index matching limits a feature point frame to be matched, thereby enabling a faster comparison. In FIG. 5, original indices correspond to video frame feature points of an input digital video, and search indices correspond to indices of the index table.

In this case, if there are a number of index tables, the number of indices of each frame to be matched may be set to a threshold value.

As described above, it is possible to selectively use three matching structures including matching between key-frame index tables according to a length of a digital video to be searched for, matching between a key-frame index table and a total frame index table, and matching between total frame index tables

According to the example embodiments of the present invention, it is possible to perform a fast search operation by making an arrangement for a fast comparison using feature points, which represent a digital video, not the values of the digital video itself. Two types of the total frame index table and the key-frame index table are provided as index tables for enabling fast matching, so that a matching operation can be efficiently performed by configuring three types of matching pairs according to a minimum matching time.

While the example embodiments of the present invention and their advantages have been described in detail, it should be understood that various changes, substitutions and alterations may be made herein without departing from the scope of the invention.

What is claimed is:

1. A fast matching system for a digital video, comprising:
a video feature point extractor configured to extract feature points of video frames of a digital video when the digital video is input;
a feature point index mapper configured to receive the video feature points from the video feature point extractor and configure an index table by mapping the video feature points to a plurality of indices;
a video feature point database (DB) configured to store the index table; and
a video feature point comparator configured to output video information corresponding to matched indices by comparing the video feature points extracted by the video feature point extractor with the indices of the index table stored in the video feature point DB.

2. The fast matching system of claim 1, wherein the feature point index mapper configures a total frame index table by mapping frame position information to indices assigned to feature points of all video frames constituting related moving images, and configures a key-frame index table by mapping frame position information to indices assigned to feature points of key frames among all the video frames constituting the related moving images.

3. The fast matching system of claim 1, wherein the video feature point extractor includes:
a video decoding unit configured to recover video frames by decoding a compressed digital video;
a video feature extraction unit configured to extract feature points and video frame information from all the recovered video frames; and
a video feature arrangement unit configured to arrange the video frame information in correspondence with the video feature points.

4. The fast matching system of claim 1, wherein the feature point index mapper includes:
an index extraction unit configured to receive the video feature points and video frame information corresponding to the video feature points and extract indices corresponding to the feature points from the video frame information;
a total index arrangement unit configured to configure a total frame index table by mapping video frame information to indices assigned to feature points of all video frames constituting related moving images; and
a key-frame index arrangement unit configured to configure a key-frame index table by mapping video frame information to indices assigned to feature points of key frames among all the video frames constituting the related moving images.

5. The fast matching system of claim 4, wherein the video frame information includes information regarding positions of the video frames.

6. The fast matching system of claim 1, wherein the video feature point comparator receives the video feature points from the video feature point extractor, and compares indices corresponding to feature points of all received frames with indices of a total frame index table stored in the video feature point DB.

7. The fast matching system of claim 1, wherein the video feature point comparator receives the video feature points from the video feature point extractor, and compares indices corresponding to feature points of a key frame among all received frames with indices of a key-frame index table stored in the video feature point DB.

8. The fast matching system of claim 1, wherein the video feature point comparator receives the video feature points from the video feature point extractor, and compares indices corresponding to feature points of a key frame among all received frames with indices of a total frame index table stored in the video feature point DB.
